(19) United States
(12) Patent Application Publication
(10) Pub. No.: US 2013/0053247 A1
(43) Pub. Date: Feb. 28, 2013

(54) INCREASING PARTICLE SIZE OF PESTICIDES TO REDUCE MOVEMENT IN SOIL

(71) Applicants: Richard K. Mann, Franklin, IN (US); David G. Ouse, Indianapolis, IN (US); Joey D. Cobb, Noblesville, IN (US); James M. Gifford, Lebanon, IN (US); Michael C. Graham, Zionsville, IN (US); James P. Mueller, Brentwood, CA (US)

(72) Inventors: Richard K. Mann, Franklin, IN (US); David G. Ouse, Indianapolis, IN (US); Joey D. Cobb, Noblesville, IN (US); James M. Gifford, Lebanon, IN (US); Michael C. Graham, Zionsville, IN (US); James P. Mueller, Brentwood, CA (US)

(73) Assignee: DOW AGROSCIENCES LLC, Indianapolis, IN (US)

(21) Appl. No.: 13/594,310

(22) Filed: Aug. 24, 2012

Related U.S. Application Data
(60) Provisional application No. 61/527,412, filed on Aug. 25, 2011.

(51) Int. Cl. A01N 25/12; A01N 37/18; B32B 5/16; A01P 13/00

(52) U.S. Cl. 504/337; 428/402

(57) ABSTRACT

This disclosure concerns the control of movement of a pesticide through soil. In some embodiments, the use of solid, large-diameter particles comprising a pesticide leads to reduced leaching of the compound from, or increased persistence of the compound in, a target area to which the compound is applied.

### CROSS-REFERENCE TO RELATED APPLICATION

This application claims the benefit of U.S. Provisional Patent Application Ser. No. 61/527,412, filed Aug. 25, 2011, the disclosure of which is hereby incorporated herein in its entirety by this reference.

### TECHNICAL FIELD

The present disclosure relates to compositions and methods for the application of chemicals (for example, pesticides and especially herbicides) to soil. Some embodiments relate to particles comprising a chemical, wherein the particles may be formed to have a large diameter sufficient to inhibit the movement of the particles through soil when compared to a chemical-containing particle having a smaller diameter.

### BACKGROUND

Particulate chemicals in water can move through soil, either horizontally or vertically, depending on water movement and physical/chemical properties of the particle and the soil. Soil is made up of different size particles that do not fit together tightly; there is “soil pore space” between the soil particles. Categories of soil pore spaces include mesopores, which are filled with water at field capacity, and are known as water storage pores for plant growth. Mesopores vary in size, typically ranging from 0.3 to 200 micrometers (μm), or 0.3 to 200 microns, distribution. The size and distribution of mesopores is dependent on soil type and structure. Other soil pore types are macropores (typically >200 micrometers (microns), which are pores that are too large to have any water capillary action, and micropores (typically <0.3 micrometers), which are too small for plants to use. Encyclopedic Dictionary of Hydrogeology, Eds. Poehls and Smith, 2009, Academic Press, New York, pp. 270-1.

The incorporation of active materials and chemicals in soil is important in a variety of contexts. For example, controlling pest and weed populations by the application of pesticide and/or herbicide compositions directly to the soil as a pre-emergence application prior to weed emergence is essential to modern agriculture. Unfortunately, many active chemical formulations lose their efficacy relatively soon after their application for many reasons. Among the factors known to influence the persistence of pesticides, the chemical stability, volatility, and solubility in plants have long been thought to be the most important. Edwards (1975) Pure and Applied Chemistry 42(1/2):39-56. When a pesticide is applied to a crop or soil, it moves from one part of the system to another, and is ultimately degraded in situ or moved out of the system. It is important to control these processes, because pesticides that move to other systems will not satisfy their intended purpose and may damage the environment. One route for reducing the activity of an active ingredient is movement through the soil following irrigation or rainfall, removing the active ingredient from the zone of weed emergence. A pesticide can disappear from soil, for example, by volatilization, leaching, surface run-off, or uptake by plants. Chemical residues that remain in plants or soil may be metabolized, but often, for persistent pesticides, these residues represent only a small proportion of the whole.

Pesticides tend to persist much longer in soil than in plants. A growing plant can metabolize or dilute chemical residues more rapidly than a comparatively static system such as soil, where the residues become tightly adsorbed on various soil fractions, and even transient pesticides may be retained much longer than they would on unreactive surfaces. The persistence of pesticides in soil depends in part on the type of soil to which they are applied, and particularly by soil characteristics such as particle size, mineral and organic content, and acidity. Their residual life also depends upon the biological activity of the soil, since the breakdown patterns of many pesticides are mediated by soil microbes.

Models useful for representing movement of chemicals in soils are generally adapted from chromatography theory. Kasten et al. (1952) J. Phys. Chem. 56:683; Littlewood and Purnell, Gas Chromatography, 1962, Academic Press, New York.; Lapidus and Amundson (1952) J. Phys. Chem. 56:984; Brenner (1962), Chem. Eng. Sci. 17:229; and Lindstrom et al. (1967) Environ. Sci. Technol. 1(7):561-5. Particulate compositions of pesticides and/or herbicides are generally desired to have a small diameter, for example, because the biological activity of a pesticide or herbicide in a small particle more closely approaches the activity of a solvent-based emulsifiable concentrate or aqueous-based pesticide or herbicide. Small particles of pesticide and/or herbicide are also generally easier to suspend in a concentrated solution.

Currently, common strategies for attempting to control the persistence of an active material or chemical in soil often include the use of an encapsulated formulation, such as a formulation that releases a chemical gradually over time. Properties of useful encapsulated formulations include good efficacy against targeted pests, ease of handling, stability, advantageous residence times in the environment and, in some instances, a long effective period of activity after its application.

### DISCLOSURE

If an active ingredient can be modified, or its physical properties improved, such that the active ingredient remains at the target site in the soil, where its activity is desired, an improved efficiency may be observed over a longer period of time. This improved efficacy may be beneficial for a pesticide, at least for the reason that less active ingredient would need to be applied over time to maintain control of susceptible pests, thus reducing the need for additional applications, reducing costs to growers, and potentially reducing any negative environmental impact resulting from movement of the active ingredient through the soil to other areas where it is not needed or intended or by repeated applications.

Disclosed herein are methods and compositions that take advantage of the finding that increasing the particle size of a solid active chemical reduces movement of the active chemical through soil. In particular examples, large-diameter pesticide particles exhibit reduced movement in a soil column leaching study, and may provide increased control of susceptible weeds by maintaining the active ingredient in the upper soil layer relative to the site of application. Thus, in embodiments, the manufacture and/or use of large-diameter particles comprising an active chemical increases the amount of the active chemical that will stay in a target area (e.g., a weed germination zone) and reduces the movement of the active chemical out of the target area due to leaching or water movement.

In some embodiments, a solid large-diameter particulate composition comprising a biologically active compound is provided. In particular embodiments, large-diameter particles may be at least about 10 μm in diameter, at least about 2 μm in diameter, at least about 30 μm in diameter, at least about 50 μm in diameter, at least about 75 μm in diameter, and at least about 100 μm in diameter (e.g., approximately 100 μm (microns) in diameter). In some embodiments, large-diameter particles comprising a biologically active compound may consist essentially of the biologically active compound or consist of the biologically active compound. For example, in particular examples, a large-diameter particle consisting of a biologically active compound may be provided by formulating the compound without milling.

In some embodiments, a solid large-diameter particulate composition comprising a biologically active compound according to the invention may persist longer in a target area to which the composition is applied than a smaller diameter particulate composition comprising the same compound. Thus, in particular examples, a solid large-diameter particulate composition may exhibit reduced movement (e.g., less movement and/or slower movement) through soil pores than a smaller diameter particulate composition comprising the same compound.

Also disclosed herein are methods for decreasing the rate at which a biologically active compound is leached or moved from a target area, as well as methods for increasing the persistence or availability of a biologically active compound in a target area. In some embodiments, a method may comprise applying a solid large-diameter particulate composition comprising a biologically active compound to a target area. In particular embodiments, a solid large-diameter particulate composition comprising a biologically active compound may be applied to a target area in a water carrier (e.g., as an aqueous suspension).

The foregoing and other features will become more apparent from the following detailed description of several embodiments, which proceeds with reference to the accompanying figures.

### BRIEF DESCRIPTION OF THE FIGURES

FIG. 1 illustrates soil columns, nine days after planting, subjected to various pesticide treatments, with and without CLING TIGHT™ adjuvant.

FIG. 2 illustrates a soil column, nine days after planting, that was treated with propyzamide, formulated in approximately 2.2 μm particles.

FIG. 3 illustrates a soil column, taken nine days after planting, that was treated with propyzamide, formulated in approximately 30 to 100 μm particles.

### DETAILED DESCRIPTION

### I. Overview of Several Embodiments

It has been discovered that the movement of an active chemical (e.g., a pesticide and especially an herbicide) through soil can be reduced by increasing the particle size of the active chemical. For example, by increasing the particle size of a solid particulate composition comprising a biologically active compound, the movement of the biologically active compound through mesopore soil pores may be significantly reduced, compared to the movement of the same biologically active compound in smaller diameter particles through mesopore soil pores. In some embodiments, movement may be reduced to such a degree that a significant impact can be measured, for example, in the efficacy of the biologically active compound in the target area to which the composition was applied (e.g., the upper soil zone). Embodiments of the invention also allow the application of smaller quantities of particulate biologically active chemicals (e.g., pesticides and herbicides) to an area to achieve a particular level of activity.

In particular embodiments, a technical grade active chemical that may be a solid may be milled such that large particle sizes (e.g., from about 20 μm to greater than about 100 μm, depending on the physical properties of the active chemical) are generated that reduce the movement of the active chemical through soil, while maintaining activity that is equivalent to, or more than, that of the same amount of the active chemical when present in a smaller particle size. Any soil-applied active chemical, or any foliar-applied active chemical that falls on the soil, may be used in certain embodiments of the invention, so long as the particle size of the active chemical can be increased (e.g., by processing) to a size where soil movement is reduced. Examples of such processing include milling of solid active or actives sprayed onto a carrier, such as but not limited to silica or clay, as well as use of filtering or centrifuging to obtain the desired particle size range. Examples of active chemicals that may be used in some embodiments include, without limitation: any pesticides, herbicides, fungicides, insecticides, biocides, rodenticides, molluscides, etc., that have preferably less than 300 parts per million (ppm) water solubility and greater than 70 degrees Centigrade melting point. In particular examples, the active chemical is a pesticide (e.g., propyzamide).

In some embodiments, a solid, large-diameter particulate composition comprising a biologically active compound may be formulated as a WDG suspension, an SC, or any other formulation type that may allow the composition to maintain a large particle size in a commercial formulation.

### II. Abbreviations

| | |
|---|---|
| ECHCG | Echinochloa crus-galli (Common barnyardgrass) |
| LOLMG | Lolium multiflorum subsp. gaudini (Annual ryegrass) |
| SC | suspension concentrate |
| SETFA | Setaria faberi (Giant foxtail) |
| TRZAS | Triticum aestivum (Spring wheat) |
| WDG | water dispersible granule |
| WP | wettable powder |

### III. Terms

Pesticide: As used herein, the term “pesticide” refers to a chemical compound that has a biological activity against an organism. Thus, a pesticide may be any substance, or mixture of substances, capable of preventing, destroying, repelling or mitigating any pest. A pesticide may be a chemical substance, biological agent (such as a virus or bacterium), antimicrobial, disinfectant, or device used against any pest. Pests include insects, plant pathogens, weeds, molluscs, birds, mammals, fish, nematodes (roundworms), and microbes that destroy property, spread disease, are a vector for disease, or cause a nuisance.

The biological activity of a pesticide is determined by its active ingredient (which may also be called the active substance). Generally, pesticide products very rarely consist of pure technical material. However, in some embodiments of the invention, a pesticide is provided as a pure technical material that is milled into large-diameter particles. The active ingredient is usually formulated with other materials, and it may be further diluted for use.

Subclasses of pesticides include, for example and without limitation: herbicides, plant growth regulators, insecticides (e.g., organochlorines, organophosphates, carbamates, pyrethroids, ovicides, larvicides, and adulticides), fungicides, rodenticides, pediculocides, biocides, algicides, avicides, bactericides, acaricides, molluscicides, nematicides, rodenticides, and virucides.

Pesticides can be classified by target organism, chemical structure, and physical state. Pesticides can also be classed as inorganic, synthetic, or biologicals (biopesticides), although this distinction may not be clear in every case. Biopesticides include, for example, both microbial pesticides and biochemical pesticides. Plant-derived pesticides (sometimes referred to as “botanicals”) include, for example and without limitation: the pyrethroids, rotenoids, nicotinoids, and a group that includes strychnine and scilliroside.

Many pesticides can also be grouped into chemical families. For example, insecticides include organochlorines, organophosphates, and carbamates. Organochlorine hydrocarbons may be further separated into dichlorodiphenylethanes, cyclodiene compounds, and other related compounds that operate by disrupting the Na⁺/K⁺ balance of insect nerve fibers, forcing the nerve to transmit continuously. Herbicides include phenoxy and benzoic acid herbicides (e.g., 2,4-D), triazines (e.g., atrazine), ureas (e.g., diuron), and chloroacetanilides (e.g., alachlor). Phenoxy compounds tend to selectively kill broadleaved weeds rather than grasses. The phenoxy and benzoic acid herbicides function similar to plant growth hormones, leading to cell growth without normal cell division, and thereby crushing the plant's nutrient transport system. Triazines interfere with photosynthesis.

In view of the foregoing, it will be clear that the term “pesticide,” for the purposes of the present disclosure, encompasses all classes of biologically active chemicals that are useful to control the population of an organism.

As used herein, the term “pest” means and includes invertebrates, organisms and microorganisms (including pathogens) that negatively affect plants or animals. This includes organisms that spread disease and/or damage the host and/or compete for host nutrients. In addition, plant pests are organisms known to associate with plants and which, as a result of that association, cause a detrimental effect on the plant's health and vigor. Plant pests include but are not limited to invasive plants (e.g., weeds), fungi, bacteria, insects, arachnids, nematodes, slugs, snails, etc.

Formulation: As used herein, the term “formulation” refers to a mixture that is prepared according to a specific procedure (i.e., the “formula”). A formulation may improve the properties of a pesticide for handling, storage, application, and may substantially influence the effectiveness and/or safety of the pesticide. Formulation terminology follows a 2-letter convention (e.g., GR denotes “granules”), listed by CropLife International in the Catalogue of Pesticide Formulation Types and International Coding System, Technical Monograph n° 2, 6^{th} Ed. However, some manufacturers do not follow these industry standards, which can cause confusion for users.

Pesticide formulations for mixing with water and application as a spray are common. Water-compatible formulations include: emulsifiable concentrates (EC), wettable powders (WP), soluble liquid concentrates (SL), and soluble powders (SP). Non-powdery formulations with reduced use (or no use) of hazardous solvents that may have improved stability include: suspension concentrates (SC), capsule suspensions (CS), and water dispersible granules (WG). Other pesticide formulations include granules (GR) and dusts (DP), although for improved safety the latter have generally been replaced by microgranules (MG). Specialist formulations are available for ultra-low volume spraying, fogging, fumigation, etc. Some pesticides (e.g., malathion) may be sold as technical material (TC—which is mostly AI, but also typically contains small quantities of (usually non-active) by-products of the manufacturing process).

### IV. Large-Diameter Chemical Particles

This disclosure provides solid large-diameter particulate compositions comprising a biologically active compound (e.g., a pesticide). Any chemical composition that may be formulated in particles may be used in some or all embodiments of the invention. In embodiments, a solid, large-diameter particulate composition comprising a biologically active compound may reduce the movement of the biologically active compound in soil to which the composition is applied, when compared to smaller diameter particles. For example, when the composition is applied to a target area, the biologically active compound may persist longer and/or remain in a greater concentration in the target area. The biologically active compound also may move at a reduced rate and/or in smaller amounts to areas adjacent and/or near to the target area (e.g., by leaching).

In some embodiments, a chemical in a large-diameter particle may be selected from a group of biologically active chemicals comprising: pesticides, more particularly herbicides, plant growth regulators, insecticides, nematocides, fungicides, and other chemicals that may be used on soil. For example, a chemical in a large-diameter particle may be a pesticide selected from a group comprising the herbicides: cyhalofop-butyl, haloxyfop, penoxsulam, flumetsulam, cloransulam-methyl, florasulam, pyroxsulam, diclosulam, fluoroxypyr, clopyralid, acetochlor, triclopyr, isoxaben, 2,4-D, MCPA, dicamba, MSMA, oxyfluorfen, oryzalin, trifluralin, benfluralin, ethalfluralin, aminopyralid, atrazine, indaziflam and other triazine herbicides, tebuthiuron, pendimethalin, propanil, saflufenacil and propyzamide. In some examples, a chemical in a large-diameter particle may be a liquid or a low melting technical material. In some examples, a silica may be used as a carrier, and then milled to a particular large-particle size. Thus, a liquid or low melting technical material together with a silica carrier may act as a solid.

In further embodiments, a chemical in a large-diameter particle may be a pesticide selected from a group comprising the insecticides: organophosphate insecticides (e.g., chlorpyrifos), molt accelerating compounds (e.g., halofenozide, methoxyfenozide and tebufenozide), pyrethroids (e.g., gamma-cyhalothrin and deltamethrin), and biopesticides (e.g., spinosad and spinetoram), sulfoxaflor, and neonicotinoids. A chemical in a large-diameter particle may also be a pesticide selected from a group comprising the fungicides: mancozeb, myclobutanil, fenbuconazole, zoxamide, propiconazole, quinoxyfen and thifluzamide.

In some embodiments, a large-diameter particle may be greater than about 10 μm in diameter. For example, in particular embodiments, a large-diameter particle may be at least about 15 μm in diameter, at least about 20 μm (e.g., at least about 21, 22, 23, 24, 25, 26, 27, 28, 29 μm, etc.) in diameter, at least about 30 μm in diameter, at least about 40 μm in diameter, at least about 50 μm in diameter, at least about 60 μm in diameter, at least about 70 μm in diameter, at least about 80 μm in diameter, at least about 90 μm in diameter, at least about 100 μm in diameter, and at least about 110 μm, or more, in diameter.

A large-diameter particulate composition comprising a pesticide may include other compounds. For example, in some embodiments, a pesticidal composition may include between about 1 weight percent and about 20 weight percent (e.g., from about 1 weight percent to about 7 weight percent) of at least one surfactant. A surfactant may be anionic, cationic, or nonionic in character. Typical surfactants include, without limitation: salts of alkyl sulfates (e.g., diethanolammonium lauryl sulfate), alkylarylsulfonate salts (e.g., calcium dodecylbenzenesulfonate), alkyl and/or arylalkylphenol-alkylene oxide addition products (e.g., nonylphenol-C18 ethoxylate), alcohol-alkylene oxide addition products (e.g., tridecyl alcohol-C16 ethoxylate), soaps (e.g., sodium stearate), alkylnaphthalenesulfonate salts (e.g., sodium dibutylnaphthalenesulfonate), dialkyl esters of sulfosuccinate salts (e.g., sodium di(2-ethylhexyl) sulfosuccinate), sorbitol esters (e.g., sorbitol oleate), quaternary amines (e.g., lauryl trimethylammonium chloride), ethoxylated amines (e.g., tallowamine ethoxylated), betaine surfactants (e.g., cocoamidopropyl betaine), polyethylene glycol esters of fatty acids (e.g., polyethylene glycol stearate), block copolymers of ethylene oxide and propylene oxide, salts of mono and dialkyl phosphate esters, and mixtures thereof.

In particular embodiments, a surfactant may be selected from a group comprising polymers, sulfates of alkoxylated alkanoles, fatty alcohol polyglycol ethers, and polysorbates. By way of example and not limitation, the surfactant may be a C12 alcohol ethoxylate, such as an ethoxylated lauryl alcohol surfactant. An example of such an ethoxylated lauryl alcohol surfactant is Renex 30, which is commercially available from Croda Corporation. A polymeric surfactant, such as that commercially available from IIuntsman International LLC (The Woodlands, Tex.) under the trademark TERSPERSE® 2500 series, may also be employed. An alcohol polyglycol ether, such as ETHYLAN™ NS 500 LQ alcohol polyglycol ether (Akzo Nobel, Chicago, Ill.), may also be employed. For example, the pesticidal composition may include a combination of between about 0.05 weight percent and about 2 weight percent (e.g., about 0.3 weight percent) of the Renex 30, between about 0.5 weight percent and about 4 weight percent, and, for example, about 1.9 weight percent of the TERSPERSE® 2500 series and the ETHYLAN™ NS 500 LQ.

A pesticidal composition may also optionally include a thickener. For example, in some embodiments, a pesticidal composition may include between about 0.05 weight percent and about 0.5 weight percent of a thickener. One example of a thickener is an organic gum (e.g., xanthan gum, such as KELZAN® S xanthan gum). For example, in particular embodiments, a pesticidal composition may include about 0.2 weight percent of KELZAN® S xanthan gum.

A pesticidal composition may also optionally include a dispersant. For example, in some embodiments, a pesticidal composition may include between about 0.5 weight percent and about 6 weight percent of a dispersant. One example of a dispersant is MORWET® D-360 powder (Akzo Nobel), which includes a blend of an alkyl naphthalene sulfonate condensate and lignosulfonate. For example, in particular embodiments, a pesticidal composition may include about 2.9 weight percent of MORWET® D-360 powder.

A pesticidal composition may also optionally include a preservative. For example, in some embodiments, a pesticidal composition may include between about 0.02 weight percent and about 6 weight percent of a preservative. One example of a preservative is PROXEL® GXL preservative (Arch UK Biocides Limited, England), which may be used in a concentration of from about 0.02 weight percent to about 0.3 weight percent. For example, in particular embodiments, a pesticidal composition may include about 0.1 weight percent of PROXEL® GXL preservative.

A pesticidal composition may also optionally include a rheology stabilizer. For example, in some embodiments, a pesticidal composition may include between about 0.5 weight percent and about 6 weight percent of a rheology stabilizer. One example of a rheology stabilizer is a microcrystalline cellulose gel (e.g., AVICEL® CL 611 rheology stabilizer; FMC Corporation (Philadelphia, Pa.)). For example, in particular embodiments, a pesticidal composition may include about 1.1 weight percent of the AVICEL® CL 611 rheology stabilizer.

A pesticidal composition may also optionally include between about 0.05 weight percent and about 1 weight percent of a buffer. The buffer may include, for example, and aqueous solution of a weak acid and its conjugate base of a weak base and its conjugate acid. The buffer solution may be formulated to maintain a desired pH of the insecticide formulation.

In particular embodiments, a pesticidal composition may also include between about 2 weight percent and about 10 weight percent and, more particularly, between about 3 weight percent and about 6 weight percent of the propylene glycol.

In some embodiments, a base formulation may be combined with a liquid carrier and a self-emulsifiable ester. Examples of suitable liquid carriers include, but are not limited to: liquid carriers including benzene, alcohols, acetone, xylene, methylnaphthalene, dioxane and cyclohexanone. Examples of self-emulsifiable esters include, but are not limited to succinate triglyceride oil derived from maleating triglyceride oil (e.g., VEG-ESTER® additives available from Lubrizol, Inc.). For example, a pesticidal composition may be fanned by combining between about 10 weight percent and about 30 weight percent of the base formulation with between about 30 weight percent and about 50 weight percent of each of cyclohexanone and VEG-ESTER® GY-350 additive. Further examples of the use of self-emulsifiable carriers in pesticide application are provided in U.S. Patent Application 2010/0113275.

A large-diameter particulate composition comprising a biologically active compound may also optionally comprise one or more fillers in some embodiments. Fillers which may be incorporated into a large-diameter chemical particle may include, for example, powdered or granular materials, including without limitation: silicas, diatomites, attapulgites, bentonites, talcs, montmorillonites, perlites, vermiculites, calcium carbonates, corncob grits, wood flour, lignin sulfonates, etc.

In addition to the formulations set forth above, large-diameter particulate compositions comprising a biologically active compound may also be included in a formulation in combination with one or more additional compatible ingredients. Other additional ingredients may include, for example and without limitation: one or more other biologically active compound(s), dyes, and any other additional ingredients providing functional utility (e.g., fragrances, viscosity-lowering additives, and freeze-point depressants).

Kits and suspensions comprising a solid, large-diameter particulate composition comprising a biologically active compound are also provided in some embodiments. In particular examples, a kit may comprise solid, large-diameter particles comprising an active compound, and may further comprise other ingredients and/or materials to be incorporated in a formulation with the particles.

While it is possible to utilize the compounds directly as herbicides, it is preferable to use them in mixtures containing a herbicidally effective amount of the compound along with at least one agriculturally acceptable adjuvant or carrier. Suitable adjuvants or carriers should not be phytotoxic to valuable crops, particularly at the concentrations employed in applying the compositions for selective weed control in the presence of crops, and should not react chemically with the compounds of Formula I or other composition ingredients. Such mixtures can be designed for application directly to weeds or their locus or can be concentrates or formulations that are normally diluted with additional carriers and adjuvants before application. They can be solids, such as, for example, dusts, granules, water dispersible granules, or wettable powders, or liquids, such as, for example, emulsifiable concentrates, solutions, emulsions or suspensions. They can also be provided as a pre-mix or tank mixed.

Suitable agricultural adjuvants and carriers that are useful in preparing the herbicidal mixtures of the invention are well known to those skilled in the art. Some of these adjuvants include, but are not limited to, crop oil concentrate (mineral oil (85%)+emulsifiers (15%)); nonylphenol ethoxylate; benzylcocoalkyldimethyl quaternary ammonium salt; blend of petroleum hydrocarbon, alkyl esters, organic acid, and anionic surfactant; C₉-C₁₁ alkylpolyglycoside; phosphated alcohol ethoxylate; natural primary alcohol (C₁₂-C₁₆) ethoxylate; di-sec-butylphenol EO-PO block copolymer; polysiloxane-methyl cap; nonylphenol ethoxylate+urea ammonium nitrrate; emulsified methylated seed oil; tridecyl alcohol (synthetic) ethoxylate (8EO); tallow amine ethoxylate (15 EO); PEG(400) dioleate-99.

Liquid carriers that can be employed include water and organic solvents. The organic solvents typically used include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Specific organic solvents include toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like. Water is generally the carrier of choice for the dilution of concentrates.

Suitable solid carriers include talc, pyrophyllite clay, silica, attapulgus clay, kaolin clay, kieselguhr, chalk, diatomaceous earth, lime, calcium carbonate, bentonite clay, Fuller's earth, cottonseed hulls, wheat flour, soybean flour, pumice, wood flour, walnut shell flour, lignin, and the like.

It is usually desirable to incorporate one or more surface-active agents into the compositions of the present invention. Such surface-active agents are advantageously employed in both solid and liquid compositions, especially those designed to be diluted with carrier before application. The surface-active agents can be anionic, cationic or nonionic in character and can be employed as emulsifying agents, wetting agents, suspending agents, or for other purposes. Surfactants conventionally used in the art of formulation and which may also be used in the present formulations are described, inter alia, in “McCutcheon's Detergents and Emulsifiers Annual,” MC Publishing Corp., Ridgewood, N.J., 1998 and in “Encyclopedia of Surfactants,” Vol. I-III, Chemical publishing Co., New York, 1980-81. Typical surface-active agents include salts of alkyl sulfates, such as diethanolammonium lauryl sulfate; alkylarylsulfonate salts, such as calcium dodecylbenzenesulfonate; alkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkylnaphthalene-sulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, particularly methyl esters.

Oftentimes, some of these materials, such as vegetable or seed oils and their esters, can be used interchangeably as an agricultural adjuvant, as a liquid carrier or as a surface active agent.

Other adjuvants commonly used in agricultural compositions include compatibilizing agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like. The compositions may also contain other compatible components, for example, other herbicides, plant growth regulants, fungicides, insecticides, and the like and can be formulated with liquid fertilizers or solid, particulate fertilizer carriers such as ammonium nitrate, urea and the like.

### V. Movement of Soil-Incorporated Biologically Active Compounds Formulated in Large-Diameter Particles

Also provided are methods that take advantage of the finding that the movement of an active compound (e.g., a pesticide, and a herbicide) through soil can be reduced by increasing the particle size of the active compound. Some embodiments include methods for decreasing the rate at which an active compound is leached from a target area. These and further embodiments also include methods for increasing the persistence of an active compound in a target area. In particular examples, a solid, large-diameter particulate composition comprising a biologically active compound may be suspended in water and applied to a target area. In particular examples, a target area is an area of soil with a horizontal and a vertical dimension. A target area may be of any size.

### Movement of Large-Diameter Particles Through Soil Mesopores

Soil consists of three different phases: a solid phase that contains mainly minerals of varying sizes and organic compounds that accounts for approximately 20% of the soil space, and liquid and gas phases that are contained within the total pore space. The total pore space accounts for the remaining approximately 80% of the soil space. There are three main categories of soil pores (i.e., macropores, mesopores, and micropores) that all have different characteristics and contribute different attributes to soils, depending on the number and frequency of each type of pore that occurs in a particular soil. In some embodiments, a solid, large-diameter particulate composition comprising a biologically active compound may be applied to soil, such that the biologically active compound moves more slowly (or in smaller amounts) through the soil mesopores.

Mesopores (sometimes referred to as “storage pores”) may be, for example, between about 0.3 and 200 micrometers (microns). Mesopores are filled with water at field capacity, and are able to store water useful to plants. Mesopores do not have capillary forces so great that water becomes limiting to the plants. Mesopores ideally always contain liquid to support optimum plant growth. Macropores (e.g., greater than about 200 micrometers) are full of air at field capacity and are too large to have any significant capillary force. Macropores can be caused by cracking, division of peds and aggregates, as well as plant roots, and zoological exploration. Micropores are generally smaller than both mesopores and macropores (for example, smaller than about 0.3 micrometers), and are filled with water at peimanent plant wilting point. Micropores are too small for a plant to use without great difficulty. The water held in micropores is usually adsorbed onto the surfaces of clay molecules.

Soils are classified according to the proportion of mineral particles of different sizes present. The porosity of surface soil typically decreases as the particle size of the soil increases, because of soil aggregate formation in fine-textured surface soils subjected to soil biological processes. Aggregation typically involves particulate adhesion and higher resistance to compaction. For the typical bulk density of sandy soil (approximately between 1.5 and 1.7 g/cm³), the porosity is calculated to be expected to be between 0.43 and 0.36. Typical bulk density of clay soil is between 1.1 and 1.3 g/cm³, which implies a porosity between 0.58 and 0.51. The porosity of subsurface soil is lower than the porosity of surface soil due to compaction by gravity. See, e.g., Brady and Weil, The Nature and Properties of Soils, 12^{th} ed., Upper Saddle River, N.J., Prentice-Hall, 1999.

### Chemical Adsorption and Persistence

With a few exceptions, the smaller the particles a soil is composed of, the longer active compounds (e.g., pesticides) persist in it. This may be contrary to what would be expected, since smaller soil particles imply increased porosity (see above). Soil structure affects the leaching or downward movement of active compounds (which impacts the persistence of the compounds), because the pore size and pore size distribution greatly affect the movement of water through soil. The way in which particle size and structure influences persistence in soil is complex, because structure is also intimately linked with such features as hydrogen ion concentration, organic matter and clay content. For example, an active compound (e.g., a pesticide) may become absorbed onto soil particles, thereby increasing the persistence of the compound. Mechanisms that may be responsible for absorption in certain compound-soil combinations include: physical adsorption, chemical adsorption (i.e., ion exchange or protonation), hydrogen bonding, and coordination (metal complexes). In any one soil, several mechanisms or combinations of mechanisms may exist with regard to a particular compound. Bailey and White (1970) Res. Rev. 32:29.

In some embodiments, an active compound in a solid, large-diameter particulate composition may be absorbed onto soil particles in a target area, thereby further increasing the persistence of the active compound in the target area. In particular examples, the composition may be applied to soil in a target area having a high clay content, to further increase the persistence of the active compound in the target area. Also in particular examples, the composition may be applied to soil in a target area having a high organic matter content to further increase the persistence of the active compound in the target area.

In general, factors that may influence the amount of adsorption of active compounds by soil colloids include: the physicochemical configuration of the soil particles, the physicochemical configuration of the compound, the dissociation constant of the compound, the water-solubility of the compound, the molecular size of the compound, the soil acidity, temperature, the electrical potential of the soil clay surface, the moisture content of the soil, and the compound formulation. Clay and organic matter are two particular soil constituents that may influence the persistence of pesticides in soils.

Clay particles are the smallest particles in soil (about 2 μm), and soils with more than 40% of clay particles are referred to as clay soils. Such soils have a much larger internal reactive surface area than other soils, thus providing a greater surface area for adsorption of pesticides. There is a strong correlation between the amount of clay in a soil and the ability of the soil to bind and retain pesticides.

The amount of organic matter in particular soils may be, for example, from less than about 1% to more than about 50%. Soil organic matter contributes to the adsorption of pesticides and there is a correlation between the persistence of pesticides in soils and the amount of organic matter in them. Most of soil organic matter consists of humic compounds that have not been completely characterized, but do have a very high cation exchange capacity. Humic compounds may have functional groups, such as, for example, carboxyl, amino, and phenolic hydroxyl, which may provide sites for hydrogen bonding with certain pesticide molecules.

### Application of Solid, Large-Diameter Particulate Compositions

A solid, large-diameter particulate composition comprising a biologically active compound may be applied to a target area by any method known to those of skill in the art. For example, in particular embodiments, a solid, large-diameter particulate composition may be applied by seed treatment, pre-emergence spray application, post-emergence spray application, controlled droplet application, granule application, chemical irrigation, aerial spraying, ultra-low volume spray application, or crop dusting. In some embodiments, the solid, large-diameter particulate composition may be applied to a target area in a liquid suspension. In other embodiments, the solid, large-diameter particulate composition may be applied in dry form. Compositions applied in dry form may later be suspended in water, for example, by rain water or irrigation.

One of the more common forms of chemical application, especially in conventional agriculture, is spray application, such as, for example, application using mechanical sprayers. Hydraulic sprayers that may be used to accomplish spray application may consist of a tank, a pump, a lance (for single nozzles) or boom, and a nozzle (or multiple nozzles). Sprayers may convert a chemical formulation (e.g., a suspension of solid, large-diameter particles comprising an active compound), often containing a mixture of a liquid carrier (e.g., water and fertilizer) and chemical, into droplets. This conversion is accomplished by forcing the spray mixture through a spray nozzle under pressure. The size of droplets produced during spraying may be altered through the use of different nozzle sizes, by altering the pressure under which it is forced, or a combination of the foregoing. Large droplets may have an advantage of being less susceptible to “spray drift,” but generally require more water per unit of target area. Due to static electricity, small droplets may be able to maximize contact with a target organism in the target area, but small droplets are susceptible to spray drift (e.g., during application during periods of high wind).

Air-assisted or mist sprayers may be used for post-emergence pesticide application to tall crops, such as tree fruit, where boom sprayers and aerial application would be ineffective. Air-assisted sprayers inject a small amount of liquid into a fast-moving stream of air, which break down large droplets into smaller droplets. Foggers use a different method to fulfill a similar role to air-assisted sprayers in producing particles of very small size. Whereas air-assisted sprayers create a high-speed stream of air which can travel significant distances, foggers use a piston or bellows to create a stagnant area of pesticide that is often used for enclosed areas, such as houses and animal shelters.

Seed treatment represents a further category of application methods that may achieve a high effective dose-transfer efficiency in some embodiments. Seed treatment generally comprises the application of an active compound to a seed prior to planting, in the form of a seed treatment, or coating, to protect against soil-borne risks to the plant. Compositions for seed treatment may additionally provide supplemental chemicals and nutrients that encourage plant growth. A seed coating may include a nutrient layer (containing, e.g., nitrogen, phosphorus, and potassium), a rhizobial layer (containing, e.g., symbiotic bacteria and other beneficial microorganisms), and a pesticide layer to make the seed less vulnerable to pests.

The following examples are provided to illustrate certain particular features and/or embodiments. The examples should not be construed to limit the disclosure to the particular features or embodiments exemplified.

### EXAMPLES

### Example 1

### Large-Diameter Pesticide Particles

Propyzamide (pronamide) was selected to study the movement of large-diameter chemical particles through soil and is available as a solid, technical material. Commercially available propyzamide products (Kerb™ Flo; registered trademark of Dow AgroSciences, LLC) have a median particle size diameter (d.50) of milled product of approximately 2.2 μm. Technical propyzamide was formulated without milling into particle sizes ranging mostly from about 30 μm to about 100 μm in diameter (e.g., d.50=30 μm, d.90=212 μm). This large diameter propyzamide formulation is referred to herein as “the approximately 100 μm particle size product.” The term, “d.50,” refers to the diameter of particles where 50% of all particles are smaller than that size. Likewise, the term, “d.90,” refers to the diameter of particles where 90% of all particles are smaller than that size.

### Example 2

### Efficacy of Large-Diameter Pesticide Particles

The approximately 100 μm particle size product was determined to provide about equivalent or better biological (herbicidal) activity, when compared to Kerb™ Flo (d.50≈2.2 μm) in pre-emergence tests. Results from greenhouse trials testing the two propyzamide formulations (Kerb™ Flo and the approximately 100 μm particle size product) demonstrated that the approximately 100 μm size propyzamide product was typically at least as herbicidally active as the commercial 2.2 μm size product applied at equivalent rates. At lower test rates, the 100 μm propyzamide product provided equal or significantly greater grass weed control of tested species than the 2.2 μm commercial product.

Tables 1 and 2 demonstrate the equal or significantly greater herbicidal efficacy imparted by the approximately 100 μm particle size product as compared to the commercial 2.2 μm propyzamide product (Kerb™ Flo) when measured as percent plant growth reduction relative to untreated control plants. This is seen in particular at the lower use rates of the active ingredient. Table 1 demonstrates at the lower use rates that the approximately 100 μm particle size product provides better control of ECHCG (barnyardgrass), SETFA (giant foxtail), and TRZAS (spring wheat) than Kerb™ Flo (d.50≈2.2 μm). Table 2 demonstrates this same effect on TRZAS and LOLMG (annual ryegrass).

TABLE 1
Pre-emergence herbicidal efficacy comparison between Kerb ™ Flo (~2.2 μm particle
size formulation) versus the approximately 100 μm particle size product

| Treatment | Treatment | Conc. | Rate | | | | |
|---|---|---|---|---|---|---|---|
| Number | Name | (lb. ai/gal) | (lb. ai/a) | ECHCG* | SETFA* | TRZAS* | LOLMG* |
| 1 | KERB | 3.33 | 0.125 | 27.5 c | 0.0 d | 0.0 g | 100.0 a |
| | FLO 2.2 μm | | | | | | |
| 2 | KERB | 3.33 | 0.25 | 87.0 a | 60.0 c | 52.5 de | 100.0 a |
| | FLO 2.2 μm | | | | | | |
| 3 | KERB | 3.33 | 0.5 | 100.0 a | 80.0 abc | 65.0 bcd | 95.0 ab |
| | FLO 2.2 μm | | | | | | |
| 4 | KERB | 3.33 | 1 | 100.0 a | 95.8 ab | 96.3 a | 100.0 a |
| | FLO 2.2 μm | | | | | | |
| 5 | 100 μm | 3.33 | 0.125 | 85.0 a | 6.3 d | 32.5 ef | 90.0 b |
| | propyzamide | | | | | | |
| | formulation | | | | | | |
| 6 | 100 μm | 3.33 | 0.25 | 90.0 a | 85.8 ab | 86.3 abc | 100.0 a |
| | propyzamide | | | | | | |
| | formulation | | | | | | |
| 7 | 100 μm | 3.33 | 0.5 | 100.0 a | 95.0 ab | 78.8 abcd | 100.0 a |
| | propyzamide | | | | | | |
| | formulation | | | | | | |
| 8 | 100 μm | 3.33 | 1 | 100.0 a | 94.5 ab | 100.0 a | 100.0 a |
| | propyzamide | | | | | | |
| | formulation | | | | | | |
| 18 | UNTREATED | | 0 | 0.0 d | 0.0 d | 0.0 g | 0.0 c |

*Means followed by same letter do not significantly differ (P = .05, Duncan's New MRT)

TABLE 2
Additional pre-emergence herbicidal efficacy comparison between Kerb ™ Flo (~2.2 μm
particle size formulation) versus the approximately 100 μm particle size product

| Treatment | Treatment | Conc. | Rate | | | | |
|---|---|---|---|---|---|---|---|
| Number | Name | (lb. ai/gal) | (lb. ai/a) | ECHCG* | SETFA* | TRZAS* | LOLMG* |
| 1 | KERB | 3.33 | 0.0625 | 71.5 bcd | 75.0 bc | 16.3 ef | 0.0 e |
| | FLO 2.2 μm | | | | | | |
| 2 | KERB | 3.33 | 0.125 | 58.8 de | 62.5 cd | 65.0 abcd | 82.0 abc |
| | FLO 2.2 μm | | | | | | |
| 3 | KERB | 3.33 | 0.25 | 95.8 a | 89.5 ab | 98.8 a | 85.0 abc |
| | FLO 2.2 μm | | | | | | |
| 4 | KERB | 3.33 | 0.5 | 100.0 a | 99.3 a | 77.5 abc | 98.8 a |
| | FLO 2.2 μm | | | | | | |
| 5 | 100 μm | 3.33 | 0.0625 | 48.8 e | 88.3 ab | 53.8 bcd | 51.3 d |
| | propyzamide | | | | | | |
| | formulation | | | | | | |
| 6 | 100 μm | 3.33 | 0.125 | 66.3 cde | 91.3 ab | 78.5 abc | 85.0 abc |
| | propyzamide | | | | | | |
| | formulation | | | | | | |
| 7 | 100 μm | 3.33 | 0.25 | 99.0 a | 97.3 a | 63.8 abcd | 94.5 ab |
| | propyzamide | | | | | | |
| | formulation | | | | | | |
| 8 | 100 μm | 3.33 | 0.5 | 96.5 a | 99.5 a | 96.0 a | 100.0 a |
| | propyzamide | | | | | | |
| | formulation | | | | | | |
| 18 | UNTREATED | | 0 | 0.0 g | 0.0 g | 0.0 f | 0.0 e |

Means followed by same letter do not significantly differ (P = .05, Duncan's New MRT)

### Example 3

### Leaching of Large-Diameter Pesticide Particles

The movement of the 100 μm propyzamide particles through soil was significantly reduced compared to the commercial 2.2 μm product. Results from a replicated soil column leaching study clearly demonstrated that the approximately 100 μm particle size product did not move as far through the soil columns as the 2.2 μm commercial propyzamide product (Kerb™ Flo). The Soil Mobility Ratio (referred to as “Rf”) was measured as the movement of active ingredient (propyzamide) away from the site of application in millimeters (judged by plant injury or emergence inhibition), divided by the total distance of the wetting front (in millimeters). Results of the soil column movement/leaching study are shown in Table 3.

In this study, the two propyzamide formulations (2.2 μm and 100 μm) were moved, or “leached,” via water capillary action through soil columns containing a 60/40 ratio of mineral soil/grit that could be classified as a medium soil type. The columns were packed with soil to a depth of 35 cm, and placed on a vortex to solidly pack the soil. A weighted bottle was also used to compact the surface (sand fill bottle almost fits the cylinder tightly). Repeated pounding and hitting the bottom of the column on a hard surface increased compaction.

Treatments were applied in 1.5 mL aliquots to the soil using a TN-3 hollow cone nozzle attached to a syringe, providing 5 sprays per column surface area. Propyzamide was applied at 10 lbs. ai/acre at the top of the soil columns. Soil columns were inverted and placed in water, and water was allowed to move up the soil columns via capillary action. The water front (the furthest water position) was marked when the front reached the opposite end of the soil column.

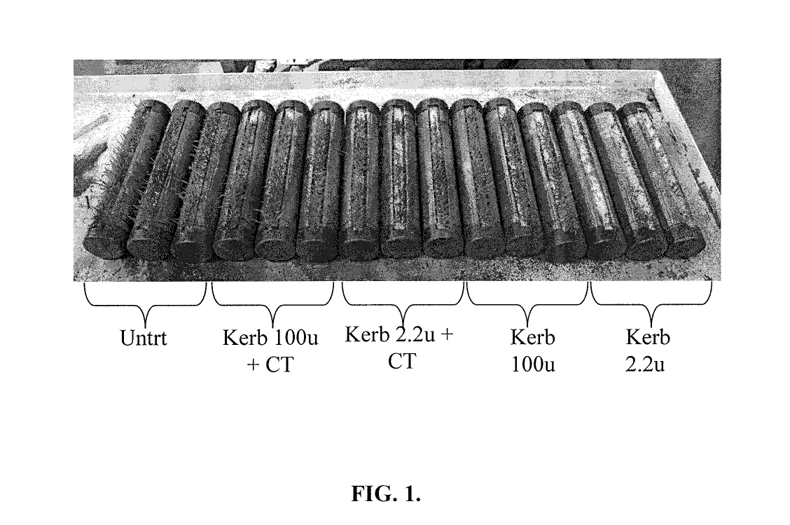

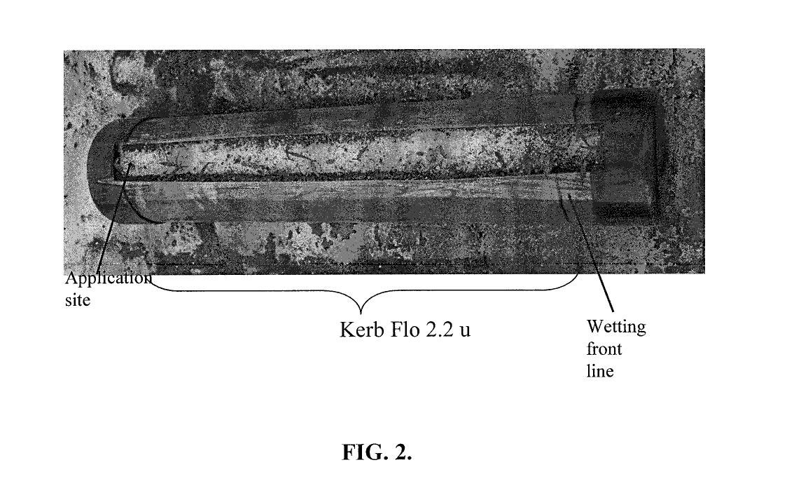

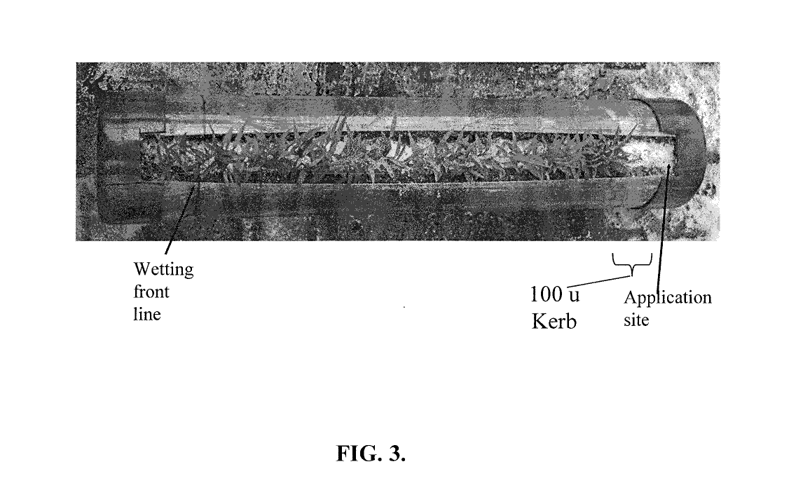

Results of the mobility of the different particle size propyzamide ulations can be seen in Table 3. The Kerb™ Flo (2.2 μm) product moved with the water front, providing control of the bioassay grass species, SETFA, along the whole distance of the water movement (treatment #1), with a Rf measurement of 1.0. The approximately 100 μm particle size product moved approximately 13% of the distance of the water movement (Rf of 0.13). FIGS. 1-3. The observed reduction in movement was significant.

Cling Tight™ (registered trademark of Western Farm Service, Inc) (identified as “CT” in FIG. 1) adjuvant is a commercially available adjuvant product that claims to reduce the movement of pesticides through soil. Inclusion of Cling Tight™ adjuvant in the formulation did slightly reduce movement of the Kerb™ Flo (2.2 μm) through soil, but did not appear to have any impact on the approximately 100 μm particle size product. This lack of an effect is most likely due to the significant impact that the larger particle size already had on the movement of the propyzamide particles through the soil.

TABLE 3
Rf results for different propyzamide formulation particle sizes.
Soil Column Treatment for Mobility

| | | Distance | Distance | | |
|---|---|---|---|---|---|
| | Surface application | traveled (mm) | of wetting | | |
| | equivalent = | (Injury and | front | Rf | |
| TRT | 10 Lb/A | suppression) | (mm) | ratio | Average |
| 1 | Kerb ™ Flo | 344 | 344 | 1.00 | 1.00 |
| | (2.2 μm) | 335 | 335 | 1.00 | |
| | | 340 | 340 | 1.00 | |
| 2 | ~100 μm | 60 | 320 | 0.19 | 0.13 |
| | propyzamide | 40 | 315 | 0.13 | |
| | formulation | 25 | 335 | 0.07 | |
| 3 | Kerb ™ Flo + Cling | 130 | 313 | 0.42 | 0.33 |
| | Tight ™* | 150 | 315 | 0.48 | |
| | | 35 | 330 | 0.11 | |
| 4 | ~100 μm | 35 | 332 | 0.11 | 0.13 |
| | propyzamide | 47 | 315 | 0.15 | |
| | formulation + Cling | 44 | 324 | 0.14 | |
| | Tight ™* | | | | |
| 5 | Water only | 0 | 335 | 0.00 | 0.00 |
| | | 0 | 330 | 0.00 | |
| | | 0 | 318 | 0.00 | |

*“Cling Tight ™” is a commercially available non-ionic spreader sticker surfactant used to protect pesticides from rainfall erosion and consists of pinene (terpene) polymers, petrolatum and alpha-(p-dodecylphenyl)-omega-hydroxypoly(oxyethylene) polymer.

While this invention has been described in certain embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims and their equivalents.

What may be claimed is:

1. A solid large-diameter particulate suspension concentrate comprising particles of a pesticide that have a d.50 of about 15 μm.

2. The solid large-diameter particulate composition of claim 1, wherein the pesticide is propyzamide.

3. The solid large-diameter particulate composition of claim 1, comprising particles of the pesticide that are at least about 20 microns in diameter.

4. The solid large-diameter particulate composition of claim 1, comprising particles of the pesticide that are at least about 50 microns in diameter.

5. The solid large-diameter particulate composition of claim 1, comprising particles of the pesticide that have a d.90 of about 250.

6. The solid large-diameter particulate composition of claim 1, wherein the composition comprises particles that consist essentially of the pesticide.

7. The solid large-diameter particulate composition of claim 1, wherein the composition comprises particles that consist of the pesticide.

8. The solid large-diameter particulate composition of claim 7, wherein the particles are a technical material.

9. A formulation comprising the solid large-diameter particulate composition of claim 1.

10. The formulation of claim 9, wherein the formulation is a liquid suspension.

11. The formulation of claim 10, wherein the liquid suspension is a water suspension.

12. The formulation of claim 9, further comprising at least one compatible ingredient selected from the group consisting of surfactants, thickeners, dispersants, preservatives, stabilizers, buffers, propylene glycol, self-emulsifiable esters, liquid carriers, fillers, dyes, fragrances, viscosity-lowering additives, freeze-point depressants, and other biologically active compounds.

13. The formulation of claim 9, wherein the formulation is suitable for soil application to a target area.

14. The formulation of claim 13, wherein the biologically active compound persists longer in the target area when it is applied than the compound persists when it is applied in a formulation having a smaller diameter particle size.

15. The formulation of claim 13, wherein the biologically active compound moves less distance from the target area when it is applied than the compound moves from the target area when it is applied in a formulation having a smaller diameter particle size.

16. The formulation of claim 9, wherein the formulation is selected from the group consisting of a water dispersible granule suspension, a suspension concentrate, and a wettable powder.

17. A method for decreasing the rate at which a biologically active compound is leached from a target area, comprising applying the solid, large-diameter particulate composition of claim 1 to the target area, wherein leaching of the biologically active compound from the target area is reduced compared to leaching of the biologically active compound from the target area when applied in a smaller diameter particulate composition.

18. The method of claim 17, wherein the target area is an area of soil with a vertical dimension and a horizontal dimension.

19. The method according to claim 18, wherein the biologically active compound is a pesticide.

20. A method for increasing the persistence of a biologically active compound in a target area, comprising applying the solid, large-diameter particulate composition of claim 1 to the target area, wherein persistence of the biologically active compound in the target area is increased compared to persistence of the biologically active compound in the target area when applied in a smaller diameter particulate composition.
